(19) United States
(12) Patent Application Publication
(10) Pub. No.: US 2007/0223871 A1
(43) Pub. Date: Sep. 27, 2007

(54) Method of Generating a Content Item Having a Specific Emotional Influence on a User

(75) Inventor: Eric Thelen, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/599,885

(22) PCT Filed: Apr. 5, 2005
(86) PCT No.: PCT/IB05/51115

§ 371 Date: Oct. 12, 2006

(30) Foreign Application Priority Data
Apr. 15, 2004 (EP) 04101552.0

(51) Int. Cl. G11B 27/034

(52) U.S. Cl. 386/52

(57) ABSTRACT

A method of processing media content, the method comprising the steps of (210) obtaining a plurality of segments of the media content, each segment being associated with a predetermined emotion of a particular user; and (230) combining the segments so as to generate a content item (300, 410) for presentation to the particular user. In a step (250) of the method, a response (390, 440) of the particular user to the generated content item (300, 410) is obtained when the generated content item is being presented. The method also comprises a step (290) of generating a new content item (350, 450) based on the content item (300, 410), using the user response (390, 440). In a further step (220, 280) of the method, a content correlation between the segments is determined, wherein the determined correlation is used for combining the segments.

The invention relates to a method of processing media content, the method comprising the step of obtaining a plurality of segments of the media content, each segment being associated with a respective predetermined emotion of a particular user. The invention also relates to a system for processing media content, the system comprising a processor configured to identify a plurality of segments of the media content, each segment being associated with a respective predetermined emotion of a particular user. The invention further relates to a method of allowing media content to be processed, and to media content data used in said method.

US2003/0118974A1 discloses a method of video indexing on the basis of a user response indicating a user emotion. The user gives the response while he is watching media content. The method uses an emotion detection system for producing indices of segments in the video content. The emotion detection system associates the segments with certain emotions of the user watching the media content. The emotion detection system may combine facial expressions of the viewers, such as a smile, and audio signals of the user's voice, such as laughter, to identify video segments as, e.g. “happy”. After the content has been indexed, the user can browse through the emotion segments within the video content by jumping to a particular segment.

The known method of video indexing allows the user to find a certain segment in the content by browsing through the media content indexed in accordance with user emotions. This known way of utilizing the index for navigation through the content is not efficient. It is time-consuming for the user to browse manually through the content to find a particular segment. The user may not have time to browse through all segments in the content to find the particular segment. Moreover, the known method does not take into account how the user wants to be presented with the segments of the content.

It is an object of the invention to provide a method of processing media content, wherein the presentation of segments to the user is improved, user-friendly and customized.

This object is realized in that the method of the present invention comprises the steps of:

obtaining a plurality of segments of the media content, each segment being associated with a respective predetermined emotion of a particular user; and

combining the segments so as to generate a content item for presentation to the particular user.

The segments associated with a specific emotion of the particular user are identified in the media content The user's emotions with regard to the segments may be determined before combining the segments. The segments to be combined may relate to substantially the same user emotion. Alternatively, the segments may relate to different emotions so as to be able to direct the user's mood. Consequently, the generated content item may have a specific emotional influence on the particular user.

The content item thus generated can be presented to the user independently of the media content from which the segments have been obtained. The presentation of the generated content item is assumed to have a stronger emotional effect on the user than the scattered presentation of the segments separately.

Various portions of media content may be used for generating the content item. For example, the segments may originate from a plurality of films and (recorded) TV programs. Furthermore, the segments may be of different types. For example, a plurality of audio segments may be combined with a plurality of video segments so that the audio and video segments are presented simultaneously. However, the audio segments and the video segments may be extracted from different portions of media content, e.g. from different albums of songs, or from different TV programs. Thus, combining the segments allows generation of the content item in a flexible way.

In one aspect of the present invention, the presentation of the generated content item affects the user so that an intense experience is created in an optimized period of time. The duration of the generated content item when presented may be much shorter than when presenting all content from which the segments are taken.

According to the method of the present invention, a response of the particular user to the generated content item may be obtained when the generated content item is being presented. The response may relate to a particular segment in the generated content item, a particular combination of the segments, or the generated content item as a whole. Thus, it enables the user to input his preferences about the way in which the content item is being generated and presented.

In contrast to the method of presenting the segments known from US2003/0118974A1, the segments are not made available separately in the present invention but are combined and the content item is generated. The generated content item can be presented in a faster way than when the user manually selects segments one by one. Furthermore, the known method allows browsing through the segments in an order in which the segments are located in the media content, the media content being a single editorial unit such as a movie or a recorded TV program. This limitation is eliminated in the present invention because the segments may be combined in any order with the generated content item. Moreover, the order of the segments in the generated content item may be personalized and modified in accordance with user preferences.

In the known method, there is no way for the user to provide an input to the emotion detection system with respect to an effect on the user of the presentation of the segments as combined. The known method only provides the possibility of detecting user emotions during the presentation of the whole media content being a single editorial unit and including certain segments, but not during the presentation of only the segments extracted from the media content. In other words, an emotional influence on the user of the presentation of the combination of the selected segments is not considered in the known method.

According to the method of the present invention, after the user has provided his response to the content item comprising the combined segments, the user's response may be used to generate a new content item. The new content item may be based on the previously generated content item. The new content item may comprise a further plurality of further segments of the media content. One or more specific ones of the further segments may include a particular one of the segments of the previous content item to which the user gave the response.

When the content item, or the new content item, is being generated, a content correlation between contents of the segments may be determined and/or used for combining the segments. “Content correlation” is understood to mean that, for example, the segments relate to the same event, e.g. a user's birthday, or the segments have a similar context, e.g. a user's hobby, images of sunsets, etc. In another example, the segments may be parts of songs of the same genre or the same artist, or the segments may be movie scenes, e.g. with the same favorite actor of the user or with similar actions such as car chases, etc.

According to a further aspect of the invention, the media content may comprise personal information from the user. For example, the segments may comprise photos of the user and his family, a user's collection of music or movies, etc. The media content may also be generic. For example, the generic media content may comprise popular music, or media content which has been positively pre-tested by a group of users.

The object of the present invention is also realized by a method of allowing media content to be processed, the method comprising the steps of:

obtaining meta-data representative of a plurality of segments of the media content, each segment being associated with a respective predetermined emotion of a particular user; and

obtaining index-data, using the meta-data, for combining the segments so as to generate a content item for presentation to the particular user.

This method of allowing media content to be processed may be implemented as a data service on a data network. The service keeps track of the emotional response of a specific user (or a statistically average user, or a user representative of a demographic sector) per segment or per content media item, and provides a list of pointers (the index data) to the end-user for automatically retrieving and combining the relevant segments. The service provider does not “obtain” and “combine” the segments in this case, but processes meta-data.

The method uses media content data comprising meta-data representative of a plurality of segments of the media content, each segment being associated with a respective predetermined emotion of a particular user, wherein the meta-data allow combination of the segments to a content item for presentation to the particular user.

The object of the invention is also realized in that the system according to the present invention comprises a processor configured to

identify a plurality of segments of the media content, each segment being associated with a respective predetermined emotion of a particular user, and

combine the segments so as to generate a content item for presentation to the particular user.

The system may operate as described with reference to the method of the present invention.

These and other aspects of the invention will be further explained, by way of example, and described with reference to the following drawings:

FIG. 1 is a functional block diagram of an embodiment of a system according to the present invention;

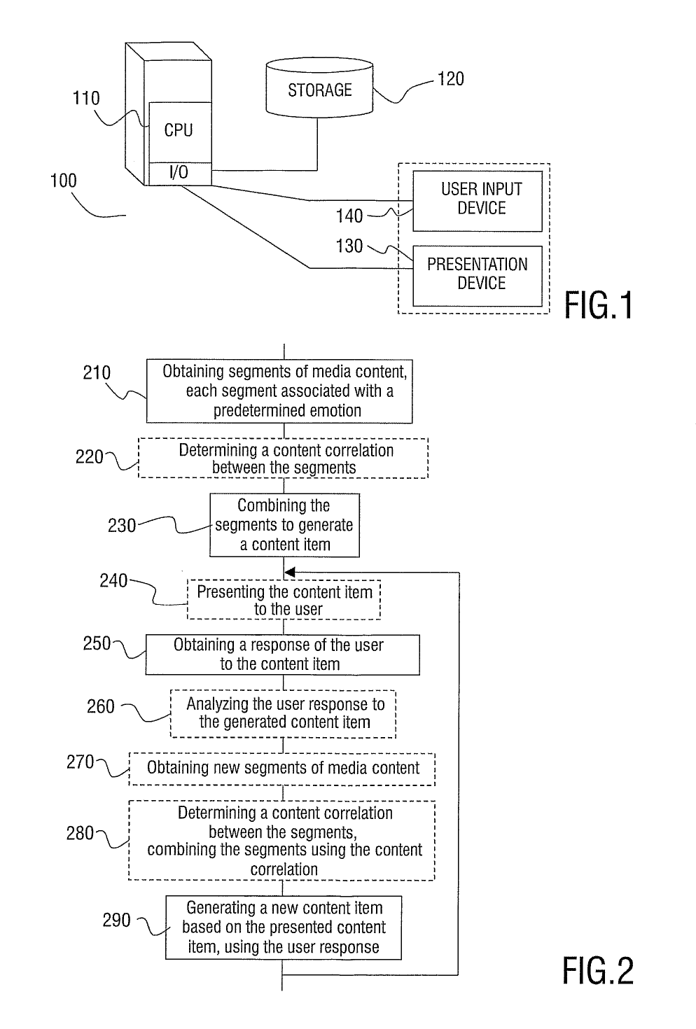

FIG. 2 is an embodiment of the method of the present invention;

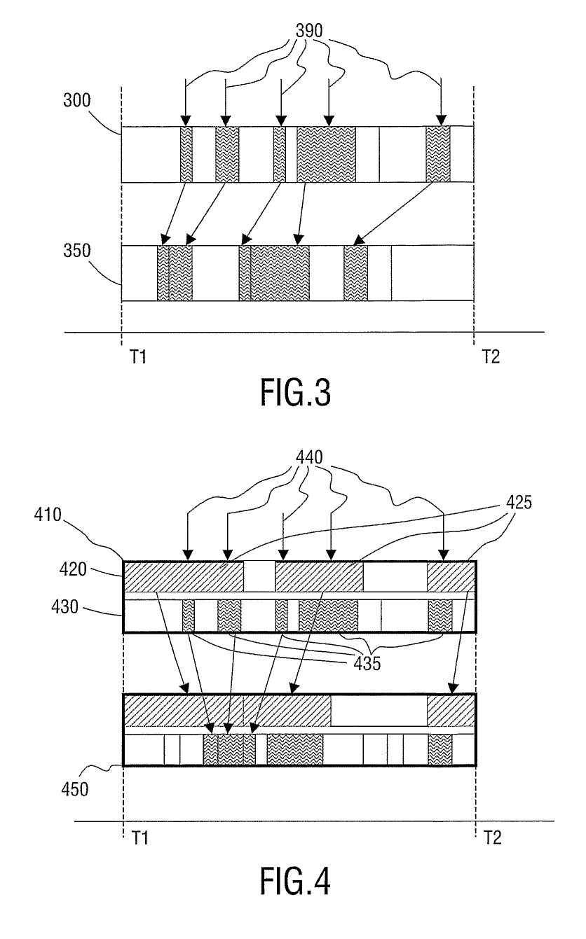

FIG. 3 illustrates the generated content item, a user response when the generated content item is being presented, and the generated new content item;

FIG. 4 illustrates the generated content item comprising audio segments and video segments, a user response when the generated content item is being presented, and the generated new content item comprising audio segments and video segments.

FIG. 1 is a block diagram of a system 100 for processing media content. The system 100 comprises a processor 110 configured to identify a plurality of segments of media content. The processor may be coupled to a media content storage device 120. For example, the processor and the storage device are arranged in the same (physical) device. In another example, the storage device is remote from the processor, e.g. the processor may access the storage device via a digital network, such as a home network, a connection to a cable-TV provider or the Internet.

The media content may comprise at least one or any combination of visual information, audio information, text, or the like. The expression “audio content”, or “audio data”, is hereinafter used as data pertaining to audio comprising audible tones, silence, speech, music, tranquility, external noise or the like. The expression “video content”, or “video data”, is used as data which are visible such as a motion picture, static (still) images, graphic symbols, etc.

The media content storage device 120 may store the media content on different data carriers such as audio tapes, video tapes, optical storage discs, e.g. a CD-ROM disc (Compact Disc Read Only Memory) or a DVD disc (Digital Versatile Disc), floppy and hard-drive disk, solid-state memory, etc. The media content may be in any format, e.g. MPEG (Motion Picture Experts Group), JPEG, MIDI (Musical Instrument Digital Interface), Shockwave, QuickTime, WAV (Waveform Audio), etc.

The processor may be arranged to process the media content and cut out (select) segments from the media content. The segments may be stared in the media content storage device 120 separately from the media content or may be stored elsewhere. Alternatively, the processor 110 may create meta-data descriptive of the media content. The meta-data may be used to unambiguously identify segments in the media content so that the segments can be easily identified and extracted from the media content and presented in real-time or scheduled (after the extraction has been completed) via a presentation device. The meta-data may be added automatically, e.g. by means of known content classification algorithms, or manually by means of explicit annotation by the user. The meta-data may include a pointer or some other mechanism for specifying segments. Markers may be used to mark the beginning and end of each specific segment. For instance, markers designate particular frames of a video sequence in the MPEG format, wherein the designated frames are at least the first and the last frame of the segment. The media content may generally be represented by a sequence of blocks, such as frames, block separately presentable in fixed time intervals, etc., depending on the format of the media content. The markers may point to such blocks. The meta-data may also include information describing the segments, e.g. a formatting type of content of the segment (audio, video, still image, etc.), a semantic type such as a genre, a source of the media content (a name of a TV channel, a title of a movie, etc.), a watching/recording history to indicate whether the segment was watched or recorded by the user, etc. The meta-data may be stored in the media content storage device 120 or at another memory means. The segments in the media content need not be contiguous, e.g. the segments may be overlapping or nested. As an alternative to the nieta-data, the processor may be arranged to insert a “segment beginning” tag and/or a “segment end” tag into the media content so as to label the beginning and the end of the particular segment.

Furthermore, the processor 110 is configured to combine the identified segments so as to generate a content item suitable for presentation to the particular user. The generation of the content item may mean that the individual segments of media content which are stored separately are being concatenated to form the content item. The separate storage of segments has the advantage that the segments are quickly accessible for combining them.

Alternatively, the segments are not separated from the media content. Instead, index data is generated, enabling the segments of media content to be presented by merely selecting the segments identified by a suitable index. Elements of the index data represent the segments of the content item and provide sufficient information to identify the segment, suitably process the corresponding media content and selectively present the segments of the media content. The extraction of the segments from the media content is not needed in this case, nor is it necessary to store the segments separately from the media content. This has the advantage that the same pieces of content are not stored twice and storage space is saved. Thus, no additional storage for the segments is required.

The index data may comprise a media content identifier to identify the media content from which the segment is obtained. For example, the media content identifier is a TV program title, a movie title, a song title and a name of an artist, or data related to audio/video parameters of the content. The media content identifier data may comprise information sufficient to retrieve the segments of media content wherever the media content is stored. A storage identifier, e.g. a URL address (Uniform Resource Locator), a network protocol address, etc. may be used to identify a remotely accessible storage device, e.g. a personal computer (PC) in a home network of a user or a web-server on the Internet. The index data may, at least partly, be created using the meta-data. For example, the information about a position of the audio segment in the song may be obtained from the meta-data.

The content item is presented by means of a presentation device 130. The presentation device may comprise a video display such as a CRT monitor, an LCD screen, etc., an audio reproduction device such as headphones or loudspeakers, or other means suitable to present media content of a specific type. The presentation device 130 may be coupled to the processor 110 so that they are accommodated in the same (physical) device. Alternatively, the processor is arranged to enable the content item to be transferred to the presentation device when the latter is remotely located. For example, the cable-TV provider equipment comprises the processor 110, and the content item is transmitted to a remote client device, accommodating the presentation device 130, via a cable-TV network. The delivery of the content item to the remote presentation device 130 may be ensured by using the index data. Actually, the processor may transfer only the index data to the presentation device. In this example, the presentation device is arranged to retrieve the segments of the content item automatically, using the index data.

The processor may be configured to obtain a response to the generated content item from a particular user. For example, the response is obtained from the user when the media content item is being presented. A user input device 140 may enable the user to input his response. For example, the input device comprises one or more buttons that the user can press when he likes a particular segment in the content item, or a particular combination of the segments. For instance, the input device may have a button indicating: “I like a segment being currently presented”, or “I like a combination of the current segment with a previously presented segment”, etc. The user may also use different buttons depending on feelings/moods/emotions evoked during the presentation of the content item, e.g. happiness, fun, sadness, anger, fear, etc. In another example, the input device includes a touch screen, a voice recognition interface, etc. In a further example, the user does not actively manipulate the input device 140 to enter his input. Instead, the input device 140 may monitor the user to deduce his emotional response. For instance, such an input device is implemented with an emotion detection system as disclosed in US2003/0118974A1. The emotion detection system comprises a video camera with an image sensor for capturing facial expressions and physical movements of the user. The system also optionally includes an audio sensor, such as a microphone, for capturing an audio signal representative of a user's voice, or a temperature sensor for measuring changes of the user's body temperature indicating, e.g. that the user is getting agitated, etc.

In one of embodiments of the present invention, the system 100 is implemented as a portable device comprising the processor 110, the user input device 140 and the presentation device 130. For example, such a portable device comprises a portable audio player, a PDA (personal digital assistant), a mobile phone equipped with a higl-quality display, or a portable PC, etc. The portable device may comprise, e.g. viewing glasses and headphones.

FIG. 2 is a diagram of an embodiment of the method of the present invention. The method comprises a step 210 of obtaining a plurality of segments of the media content.

For example, the segments are identified while the user is watching various pieces of media content such as movies, TV programs, while he is listening to music, buying audio CDs, listening to a song in the shop, etc. The segments may be marked with respect to relevant pieces of media content. For instance, the meta-data is generated to mark up the segment or segments in the media content. The meta-data may be accumulated and created whenever the user emotion of a predetermined type is detected. The meta-data can be collected automatically (implicitly) by e.g. storing information about the circumstances (e.g. date, time and other conditions of potential importance). The meta-data can also be collected manually (explicitly) by e.g. asking the user for feedback (e.g. “Did you really like that song?”) or for additional information (e.g. “Please name an artist, who you consider to be similar to this one.”).

Basically, not all segments for which, during playback, the user shows a particular emotion, need to be selected for presentation to the user. A selection from the segments may be required to find the segments to be combined in the content item. In a step 220, a content correlation between the segments of media content is determined for the purpose of finding those segments which are to be combined. According to the present invention, in addition, the segments may be associated with substantially the same emotion, and they may be content-correlated.

Indeed, correlation values between the segments associated with the predetermined emotion may be used to generate the content item. For example, two or more segments are combined if they have a particular predetermined correlation value or if a determined correlation value is beyond a certain preset threshold. Such a correlation value indicates how the segments in the content item are correlated. In one example, the correlation may represent a degree at which a particular user perceives a relation between two or more segments, based on the semantic content of the segments. For example, the correlation value may be negative or positive. An example of a positive correlation value relates to two segments, the first of which is, for example, a short movie segment of the user on holiday at the seaside, and the second is another movie segment with a similar theme, for example, a movie segment about the user's family on another holiday. Without the selection of the first segment, the second segment in itself need not be selected, for example, because the user seldom selected one of the segments for watching.

Such correlation values may be included in the meta-data for given segments, i.e. information about the second segment and the determined correlation value may be stored in the meta-data for the first segment.

Preferably, the segments to be combined are semantically not identical. A negative content correlation value may be created for the identical segments.

Alternatively or in addition to the semantic correlation between the segments, an emotion correlation is determined for specific segments. In one embodiment, the emotion correlation between the first segments is predicted, using an emotion correlation between second segments which has been determined, wherein the first segments are semantically similar to the second segments (in other words, the semantic/content correlation between the first and second segments is positive).

In one of the embodiments, the user may initially, i.e. prior to combining segments, specify a theme, topic, or provide other information about his preferences for the selection of the segments to be incorporated into the content item. A corresponding user interface means for indicating such preferences is available to the user.

In another embodiment, the selection of the segments to be combined is performed in dependence on a desired duration of the generated content item. The duration may be preset by the user or by the system. The system will then attempt to select the segments, taking into account durations of presenting the segments so that the desired duration of the content item is obtained.

In step 230, the segments are combined and the content item is generated. For example, segments are combined in a sequence so that the positive content correlation (and/or the positive emotion correlation) between the segments is adhered to. Optionally, one or more audio and/or video effects are applied to the combination of the segments. For example, a fusion, a transformation, a transition, or a distortion effect is applied. The loudness of audio segments may be modified or the brightness and color parameters of video segments may be modified. Two video segments may be shown on top of each other (in overlay mode) or next to each other. Individual segments may fade in and out or vary in intensity. Video segments may be combined with different audio segments. Artificial elements (e.g. certain sound effects such as voices of birds or certain video effects such as sparkling stars) may-be integrated in the content item as well. The use of the effects creates a natural flow of transitions between the presentations of consecutive segments. The effects help to achieve seamless transitions between the combined segments. Such techniques/effects are widely known, e.g. from the state of the art in video processing and content editing.

In a step 240, the generated content item is presented to the user using one or more presentation devices, depending on the types of media content that the presentation devices are capable to render.

The presentation of the generated content item will have a special emotional effect on the user. The effect is caused in particular by the aggregation of emotional effects of individual segments in the content item. The effect of certain combinations of the segments may also be stronger than the individual effects of the segments separately. Such combinations may also contribute to the effect of the content item on the user.

The user may like the selected segments to be incorporated into the content item, but not to the same degree. The user may prefer some segments more than other segments. Therefore, the user may want the content item to be modified in respect of specific segments or some combinations of segments. For example, the user wants to provide his response that he likes certain segments more than other segments or that he likes certain segments less than other segments. The user response to the generated content item is obtained in a step 250.

The response mechanisms may range from a simple button, which the user presses during playback of the segment that he particularly enjoys or feels affected by, to much more complex arrangements, e.g. a set of buttons for various types of emotions or a slider or wheel for a more continuous indication of a less quantized ‘level of happiness’. User feedback, i.e. the user response, may be collected via any available user interface modality, such as touch, speech or vision. Potentially, the user may be able to provide separate feedback for the audio and the video part of the generated content item.

The user response is analyzed in a step 260. The task of the system 100 is to determine on what the user provides his response. For example, the user response relates to the whole content item, to a specific segment therein, or to some segment combination.

In one example, the user response indicates that the user likes a particular segment of the generated content item. The indication may be determined by detecting an output signal corresponding to pressing the button associated with a particular user response, such as “I like the segment being currently presented”. A segment to which the response refers may thus be identified. A synchronization mechanism between segments and the user response may be employed for that purpose. The current segment is correlated with the response. A delay may occur between the effect of the segment on the user and the time at which the response is received. This delay occurs, for example, because the user may not know in advance what segments are being presented and how the presentation is affecting his mood. In addition, the user may need some time to realize that there is an emotional effect that he experiences. The synchronization mechanism is preferably arranged to take such a delay into account by associating the response with the segment which is time-shifted with respect to the response. This is particularly relevant to relatively short segments. If the system is unable to clearly identify the segment, with which the response should have been associated, the system may store the various possible hypotheses and proceed under the assumption that one of them is the correct one. During a subsequent presentation to the user, additional responses can be obtained, which will either verify or reject the hypotheses. In case of verification, the system will discard all other hypotheses. In case of rejection, the system will discard the current hypothesis and attempt to verify the next hypothesis during the next presentation to the user (‘trial and error’ approach; described also below in more detail).

If the user gives the system his response “I like the current combination of segments”, the segment which is currently being presented as well as the segment which has been previously presented may be identified. Both of these sequential segments are then considered as the combination of the segments to which the obtained response refers.

The system 100 uses the user feedback to emphasize those elements, i.e. the segments, or combinations of segments, of the content item, which have resulted in positive feedback, and/or deemphasizing those elements of the program, which have resulted in no feedback or negative feedback. By deemphasizing the respective elements, new elements, e.g. new segments, may be incorporated into the content item. The new segments of media content are obtained in a step 270, in a manner similar to that in step 210.

Optionally, the content correlations are determined in a step 280 between one or more segments of the presented content item and one or more obtained new segments. The combinations of segments with the negative content correlation are modified, e.g. one of the segments is removed from the content item.

Independently of the content correlation, if the combination of the segments has caused a user response that indicates undesirable emotional effects of this particular combination (this segment combination may further be referred to as having a negative “emotional correlation”), this particular combination may be modified, e.g. by changing the order of the segments. Thus, new combinations of segments are obtained as a result of the analysis of the user response, and a new content item is generated on the basis of the previously generated content item in a step 290.

At a more detailed level, the content may be interpreted as having multiple layers at any time, all of which contribute to the overall emotional experience of the user: the audio segments, the video segments, the audio/video effects currently being played, etc. The feedback is related especially to those elements, which are optimally synchronized with the user response. For example, when a button is pressed exactly during the period of time in which a certain image is shown, especially this image may be most strongly correlated with the obtained feedback.

At the end of the analysis, the obtained positive/negative user responses for respective elements are analyzed and the new content item is composed, i.e. generated on the basis of the results of this analysis.

If the content item was already modified by using the previous user responses for some segments incorporated into the newly generated content item, the previous responses may be taken into account.

The new content item will comprise one or more further segments, i.e. the new segments, and the segments used in the previous content item, which received a ‘good’ score (e.g. positive or neutral feedback, no feedback at all or only slightly negative feedback). The new segments, which are incorporated into the new content item, are available in the system before generation of the new content item, e.g. when the previous content was generated, but the new segments may not have obtained user responses yet. For example, the new segments have never been presented to the user before as part of any segment in the content item, but only within the context of the media content that is its source.

The analysis applied in step 260 preferably uses a reasoning mechanism for interpreting the user response. The user response may be fuzzy in the way in which the response relates to the presented content item. For example, the user response may represent any one of the statements: “I like the audio content in the content item”, “I like the current audio segment of the content item”, “I like the video part of the content item” or “I like the way in which current audio and video segments are combined in the content item”, etc.

The reasoning mechanism makes assumptions about the user response. The assumptions are used to generate the new content item. During the presentation of the new content item, the assumptions are being tested. If the segments on which the assumptions were made receive a positive user response, a neutral user response, or no user response, the assumption may be considered as being correct.

The assumption may be proven wrong. For example, the user response obtained for the new content item is not positive for the respective segments of the new content item. In that case, a further assumption may be made and used in a content item generated in future.

In summary, a ‘trial and error’ approach can be used to analyze the user response and generate the new content item. Based on the availability of new segments and on the feedback obtained during previous sessions, the system 100 hypothesizes on what the user might like and compiles the new content item accordingly. After many generations of content items, an optimized content item may gradually be obtained.

The user response is preferably analyzed with respect to consistency of the user response. For example, the user feedback appears to be inconsistent because similar segments get different feedback in the content item and the new content item (during different sessions of presenting similar segments).

Various rules can be applied to deal with such inconsistencies:

no history: only the feedback from the very last session (for the new content item) is taken into account;

a forgetting mechanism: the feedback from the very last session receives the highest weighting factor in a calculation process for calculating a weight value for the segments; the feedbacks from previous sessions gradually obtain lower weighting factors than the new content item;

an average feedback value is calculated for certain segments in the presented content items and used for generating the new content item;

a tendency: feedbacks from various sessions are accumulated, but only the feedback tendency, which is overall most prominent (positive or negative) is taken into account to decide on whether and how to incorporate specific segments into the new content item.

If the user does not provide any feedback on the presented content item, the following options may be available for generating the new content item:

a “reset” option: the segments of the presented content item may receive equal weight values, or all weight values may equal zero;

no changes: the content item may be presented another time in an unchanged form and run in exactly the same way during the next presentation.

One of the embodiments of the present invention enables the user to select the types of media content that are to be used to obtain the segments of this media content. For example, the system may present a set-up screen to the user prior to generating the content item or prior to generating the new content item. In the set-up, the user selects the types of media content such as songs, images, effects, cartoons, etc.

In an embodiment of the present invention, the generic and/or personal media content is used to obtain the segments. For example, the personal media content may comprise photos or still pictures of the user, the photos taken or collected by the user, etc. The generic content may be the content that was approved by a large number of other users as having positive emotional effects. For example, people would like an image of a kitten or a puppy, or an image with a beautiful sunset at the seaside. The personal content is more likely to evoke an emotional response from the user during the presentation of the content item comprising the segments of the personal content, rather than the segments of the generic content. The segments of the personal and generic content can be labeled accordingly to distinguish them when the segments are selected for combination in the content item.

The segments of the personal media content may be selected for combination but the content correlation between the segments may not be suitable. To combine such segments of the personal content, the segments of the generic content may be used as follows. For example, the segment of the generic content having a positive content correlation with two segments of the personal content is inserted between said segments of the personal content.

In another embodiment of the present invention, the system allows the user to select a ratio between the generic content and the personal content in the content item to be generated. For example, the ratio is calculated by determining a number of the segments of the personal content in the content item versus a number of the segments of the generic content in the same content item. In another example, the ratio is determined by calculating the playback duration of the segments of the personal video content with respect to the playback duration of the segments of the generic content in the content item.

Yet another embodiment of the present invention relates to the system arranged to generate the content items evoking a feeling of happiness. Such a system may regularly be used by the user to interact with the relevant content item in order to experience this feeling as often as possible. A very direct way of creating such an experience is achieved by means of the system and the highly personalized content item that may ultimately be generated due to the regular interaction of the user with the iteratively generated content items. Most people will experience an increased level of happiness.

FIG. 3 is a diagram of an example of a presented content item 300, and an example of a new content item 350 generated on the basis of the presented content item and the user responses 390.

The presented content item 300 has a duration (T1-T2). During the presentation of the content item, the moments when the responses 390 are being obtained are associated with particular segments of the presented content item 300. The identified segments corresponding to the responses are hatched in the Figure. The identified segments are selected for incorporating them into the new content item 350, but they are combined in a different manner. The segments of the content item 300 for which no response has been obtained are replaced, or re-combined in a different order in the new content item 350. New segments can be incorporated into the new content item 350.

FIG. 4 is a diagram of an example of the presented content item 410 comprising segments of video content 420 and segments of audio content 430. The audio content 430 and the video content 420 have equal durations when being played. The audio segments and the video segments are presented to the user simultaneously. User responses 440 are obtained at particular moments of presenting the content item. Segments 425 of the video content 420 presented at the moments when the respective responses are being obtained are identified (represented by hatched areas). Segments 435 of the audio content 430 corresponding to the responses are also identified (also represented by hatched areas). To generate the new content item 450, the identified audio and video segments are selected for combining them with new segments because some or all of the segments of the presented content item 410 were not associated with any one of the received responses 440. The rearrangement (permutation, shifting the order) of some examples of the segments from the presented content item to the new content item is indicated in FIG. 4 by corresponding arrows between the content item 410 and the new content item 450.

It should be noted that identified video segments 425 do not have the same duration as identified audio segments 435. However, both a particular audio segment and a particular video segment, which was presented at the same moment with the particular audio segment, are associated with the same response obtained at that moment. As a result of the unequal duration of such segments associated with the same response, more than one audio segment may correspond to one video segment, or vice versa. This one-too-many correspondence may be preserved when the new content item is composed. Moreover, the relationship between the audio segments and the video segments may influence the selection of the new audio segments and new video segments to be incorporated into the new content item. Basically, some new segments having a specific duration may be required so as to match the time difference between durations of the related audio and video segments, especially when the related audio and video segments are positioned at the beginning of the new content item 450.

Various computer program products may implement the functions of the device and method of the present invention and may be combined in several ways with the hardware or located in different other devices.

Variations and modifications of the described embodiment are possible within the scope of the inventive concept. For example, the system according to the present invention may be implemented with a single device, or it may comprise the service provider and the client. Alternatively, the system may comprise a device with the processor, the media content storage device and the user input device combined with the presentation device, where all devices are distributed and remotely located.

Use of the verb ‘comprise’ and its conjugations does not exclude the presence of elements or steps other than those defined in a claim. The invention can be implemented by means of hardware comprising several distinct elements, and by means of a suitably programmed computer. In the system claim enumerating several means, several of these means can be embodied by one and the same item of hardware.

1. A method of processing media content, comprising:
obtaining a plurality of segments of the media content, each respective one of the segments being associated with a respective predetermined emotion of a particular user; and
combining the segments to generate a content item for presenting to the particular user.

2. The method of claim 1, further comprising obtaining a response of the particular user to the generated content item when the generated content item is being presented.

3. The method of claim 2, further comprising generating a new content item based on the content item, using the user response.

4. The method of claim 1, further comprising determining a content correlation between the segments, wherein the determined correlation is used for combining the segments.

5. The method of claim 2, wherein the response relates to at least one of:
a particular segment of the generated content item, and
a particular combination of the segments.

6. The method of claim 1, wherein the combining comprises applying to the segments at least one of video and audio effects selected from at least one of: a fusion, a transformation, a transition, and a distortion.

7. The method of claim 1, wherein the media content comprises at least one of personal content of said user and generic content; and further comprising selecting at least one segment of the generic content to connect the segments of the personal content.

8. The method of claim 8, wherein the media content comprises at least one of personal content of said user and generic content; and further comprising controlling a ratio of the generic content to the personal content in the generated content item.

9. The method of claim 3, wherein at least one of
only the response for the content item generated for the last time is analyzed,
the response for the content item generated for the last time is weighted higher than a preceding response, and
an average of the responses for generated content items is calculated.

10. A system for processing media content, comprising:
a processor configured to
identify a plurality of segments of the media content, each respective one of the segments being associated with a respective predetermined emotion of a particular user, and
combine the segments to generate a content item for presenting to the particular user.

11. The system of claim 10, wherein the processor is configured to obtain a response of the particular user to the generated content item when the generated content item is being presented.

12. The system of claim 11, wherein the processor is configured to generate a new content item based on the content item, using the user response.

13. The system of claim 10, further comprising a user input device coupled to the processor, the user input device being arranged to enable the user to provide his response to the processor, and a presentation device for presenting the content item or the new content item to the user.

14. A computer program product enabling a programmable device when executing said computer program product to function as the system according to claim 13.

15. A method of enabling to process media content, the method comprising:
obtaining meta-data representative of a plurality of segments of the media content, each respective one of the segments being associated with a respective predetermined emotion of a particular user; and
obtaining index-data, using the meta-data, for enabling to combine the segments to generate a content item for presenting to the particular user.

16. (canceled)
